(19) United States
(12) Patent Application Publication
(10) Pub. No.: US 2006/0101213 A1
(43) Pub. Date: May 11, 2006

(54) Remote copy system and control method thereof

(76) Inventor: Toshiki Morita, Chigasaki (JP)

Correspondence Address: REED SMITH LLP, 3110 Fairview Park Drive, Suite 1400, Falls Church, VA, 22042, US

(21) Appl. No.: 11/023,430

(22) Filed: Dec. 29, 2004

(30) Foreign Application Priority Data
Nov. 9, 2004 (JP) 2004-324680

(51) Int. Cl. G06F 12/16

(52) U.S. Cl. 711/162

(57) ABSTRACT

This invention provides a control method of a remote copy system for establishing a disaster recovery system for transmitting data in database by a copy function between storage devices possessed by the storage device so as to minimize a public line necessary for the data transmission. In a remote copy system for transmitting data in a main storage device to a remote storage device, the main storage device classifies a group of logical volumes for ensuring the data update order into a plurality of small groups and sets the utilization of a side file at which the data transmission is interrupted. When the quantity of data collected in the side file exceeds a threshold, data transmission is interrupted in the order from a small group having a lower utilization of the side file without stopping the data transmission of all logical volumes in the group.

### CROSS-REFERENCE TO RELATED APPLICATION

The present application claims priority from Japanese Patent Application JP 2004-324680 filed on Nov. 9, 2004, the content of which is hereby incorporated by reference into this application.

### TECHNICAL FIELD OF THE INVENTION

The present invention relates to a control method of a remote copy system, and more particularly, it relates to a method which is effective when applied to a remote copy process for transmitting data between storage devices located at remote places.

### BACKGROUND OF THE INVENTION

Recently, in order to avoid the data loss due to disasters such as terror and earthquake, the necessity of holding copies of data accumulated in a storage device in a multiplex fashion in storage devices located at remote places has been increased in computer system.

Generally, in the disaster recovery system using the data remote copy method between the storage devices, data from a host system is written into a storage device in a main center (main site), and at the same time, the same data is written into a storage device in a remote center (remote site) installed at a remote place so as to multiplex the data.

Consequently, even if the operation of the storage device in the main center is disabled because of the disaster, it is possible to restart the operation by switching it to a storage device at a remote center (Japanese Patent Application Laid-Open No. 11-15604).

On the other hand, as for a log of database when transmitting data from the main center to the remote center, Japanese Patent Application Laid-Open No. 6-214853 has proposed a technology for restoring the database by means of data copy and log of the database in the remote center by updating the log of the remote center in synchronization with the update of the log of the main center. Consequently, even if the database is destroyed, it is possible to restore the nearest database having the consistency in a short time.

As for other technology, a technology disclosed in Japanese Patent Application Laid-Open No. 2000-347917 is available, in which database table data is written into a disk device in the main center while its update is prohibited even if a subsequent update request is issued, and the database table data of the disk device is transferred to a remote center, where the database table data is copied to duplicate the data.

Furthermore, even when a pair is formed by the remote copy, there is the possibility that data of the remote site is lost completely due to another trouble during the recovery process from a trouble. For its prevention, a method of further establishing a pair volume having the same data as that in a logical volume of the remote site has been well known (Japanese Patent Application Laid-Open No. 2002-189570).

### SUMMARY OF THE INVENTION

Meanwhile, when establishing a remote copy system, the band of a line for connecting storage devices in the main center and remote center needs to be capable of transmitting update data at a transmission peak time of that system.

Accordingly, an object of the present invention is to provide a control method of the remote copy system capable of establishing a disaster recovery system in which the data in database is transmitted by a copy function in the storage devices and realizing the function to minimize a public line necessary for the data transmission.

The typical ones of the inventions disclosed in this application will be briefly described as follows.

The present invention is applied to a remote copy system and a control method thereof, and the remote control system has a first storage device and a second storage device and transmits the data in the first storage device to the second storage device. Each of the first storage device and the second storage device comprises: an interface controller for exchanging data with the outside; a memory for temporarily storing the data; a disk drive for recording the data; a microprocessor for monitoring the data in the memory; a disk controller for controlling write and read of data in the memory to/from the disk drive; and a service processor for setting and controlling the storage devices. The remote copy system has the characteristics as follows.

(1) The memory of the first storage device has a side file for storing information for data transmission. The service processor of the first storage device has a function to classify a group of logical volumes which ensures the update order of data into a group of the logical volumes for accumulating log data and a group of the logical volumes for data other than the log data, and set the utilization of the side file at which the data transmission is interrupted.

(2) The microprocessor of the first storage device has a function to monitor the quantity of data collected in the side file and interrupt the data transmission in the order from a group having the lower utilization of the side file set previously in all the logical volumes in the group when the quantity of data collected in the side file exceeds a threshold as a result of the monitoring.

(3) The microprocessor of the first storage device has a function to restart the data transmission of a group whose data transmission is interrupted when the quantity of data collected in the side file becomes less than a threshold as a result of the monitoring.

(4) The service processor of the first storage device sets the utilization of the side file for a group of the logical volume of the log data to be high while the utilization of the side file for a group of the logical group of the data other than the log data to be low. Also, the microprocessor of the first storage device interrupts the data transmission of a group of the logical volume of the data other than the log data when the quantity of data collected in the side file exceeds a second threshold, and restarts the data transmission of a group of the logical volume of the data other than the log data whose data transmission is interrupted when the quantity of data collected in the side file becomes less than a third threshold lower than the second threshold.

(5) The microprocessor of the first storage device interrupts the data transmission of the group of the logical volume of the log data when the quantity of data collected in the side file exceeds a first threshold higher than the second threshold, and restarts the data transmission of the group of the logical volume of the log data whose data transmission is interrupted when the quantity of the data collected in the side file becomes less than a fourth threshold lower than the first threshold.

(6) The disk drive of the first storage device has a first logical volume. Also, the disk drive of the second storage device has a second logical volume and a third logical volume. Further, the microprocessor of each of the first storage device and the second storage device has a function to transmit data from the first logical volume to the second logical volume to make a copy between the storage devices, and make a copy from the second logical volume to the third logical volume within the storage device.

(7) The microprocessor of each of the first storage device and the second storage device has a function to interrupt a copy from the first logical volume to the second logical volume, make a copy from the second logical volume to the third logical volume within the device, and restore the database by using the log data and the data other than the log data in the third logical volume if a trouble occurs in the first storage device when the log data and the data other than the log data are transmitted from the first logical volume to the second logical volume.

(8) The microprocessor of each of the first storage device and the second storage device interrupts a copy of the log data from the first logical volume to the second logical volume, copies the log data of the second logical volume to the third logical volume, and restores the database by using the log data and the data other than the log data in the third logical volume if a trouble occurs in the first storage device when the log data is transmitted from the first logical volume to the second logical volume and the transmission of the data other than the log data is interrupted.

(9) The microprocessor of each of the first storage device and the second storage device interrupts a copy of the log data from the first logical volume to the second logical volume, copies the log data of the second logical volume to the third logical volume, and restores the database by using the log data and the data other than the log data in the third logical volume if a trouble occurs in the first storage device when the log data is transmitted from the first logical volume to the second logical volume, the transmission of the data other than the log data is interrupted and then restarted, and differential data is copied.

(10) The microprocessor of each of the first storage device and the second storage device restores the database by using the log data and the data other than the log data in the third logical volume if a trouble occurs in the first storage device when the transmission of the log data and the data other than the log data is interrupted or the differential data is copied after the interrupted data transmission is restarted.

The effect obtained by the representative one of the inventions disclosed in this application will be briefly described as follows.

According to the present invention, a disaster recovery system in which the data in database is transmitted in real time by the copy function of the storage devices is established, and therefore, the function to minimize the public line necessary for that data transmission can be realized.

### BRIEF DESCRIPTIONS OF THE DRAWINGS

FIG. 1 is a block diagram showing the entire structure of a remote copy system according to an embodiment of the present invention;

FIG. 2 is a block diagram showing the internal structure of a storage device in the remote copy system according to an embodiment of the present invention;

FIG. 3 is an explanatory diagram showing a pair state of logical volumes to the utilization of a side file of log data and data the other than the log data in the logical volume in a remote copy system according to an embodiment of the present invention;

FIG. 4 is an explanatory diagram showing the change in data update amount in a database in a daily operation in the remote copy system according to an embodiment of the present invention;

FIG. 5 is an explanatory diagram showing the automatic restart function of data transmission, in which FIG. 5A shows the change in data update amount in a database in a daily operation and FIG. 5B shows the change in the utilization of the side file in the remote copy system according to an embodiment of the present invention;

FIG. 6 is an explanatory diagram showing the case of creating logical volumes for the log data and the data other than the log data in the remote copy system according to an embodiment of the present invention;

FIG. 7 is an explanatory diagram. showing the case of selecting a LU desired to be set in accordance with the data transmission function setting method in the remote copy system according to an embodiment of the present invention;

FIG. 8 is an explanatory diagram showing the case of setting the copy destination VOL and the consistency group in the data transmission function setting method in the remote copy system according to an embodiment of the present invention;

FIG. 9 is an explanatory diagram showing the case of selecting a consistency group to be set in the data transmission function setting method in the remote copy system according to an embodiment of the present invention;

FIG. 10 is an explanatory diagram showing the case of setting the procedure of the side file in the data transmission function setting method in the remote copy system according to an embodiment of the present invention;

FIG. 11 is a flow diagram showing a remote data transmission control method in the remote copy system according to an embodiment of the present invention; and

FIG. 12 is a flow diagram showing the procedure in case of transmitting the update data accumulated in the bit map to a remote storage device in the remote copy system according to an embodiment of the present invention.

### DESCRIPTIONS OF THE PREFERRED EMBODIMENTS

<Concept of the Present Invention>

Generally, in the remote copy system for transmitting data from the main site to the remote site, database is often applied as its objective data. The database includes a log data, which is the data for managing update information of the database. If this log data is used, at the time of recovery against a trouble, data in the database can be recovered to updated one by reflecting subsequent log data (update information) on the data of database at a certain point of time.

If attention is paid to this property of the database, a following system can be considered as a system for transmitting data.

That is, a first aspect of the present invention concerns a system for transmitting only log information of updated data. According to this system, since the transmitted data is only log file, its necessary line band can be small, and thus, the operation cost can be reduced.

However, the log data (information) transmitted to the remote site needs to be reflected on the database at a certain point of time. Due to the time necessary for this reflection, a restriction is imposed on the operation in some cases. Thus, according to a second aspect of the present invention, the state in which the entire database is transmitted is continued as long as a data transmission band allows the state, and if the data to be transmitted exceeds the transmission band, the transmission is switched to log data transmission.

Here, the remote copy will be briefly described. The remote copy is largely classified to two. One of them is synchronous remote copy and the other is asynchronous remote copy. The synchronous remote copy refers to a system in which after a storage device in the main site receiving a data write instruction from a host system confirms that the data write instruction is completed also in the storage device in the remote site, the completion of the write instruction is notified to the host system. In this case, data image held by the storage device in the main site and data image held by the storage device in the remote site can maintain the same state during the operation thereof.

On the other hand, according to the method called asynchronous remote copy, when the storage device in the main site receives a data write instruction from the host system, the completion of the data write process is notified to the host system immediately after the process ends. Then, transmission of data to the storage device in the remote site is carried out asynchronously with that write process. In this case, the storage device in the main site holds the data to be transmitted to the storage device of the remote site in a predetermined memory (hereinafter, referred to as side file). Then, data in the side file is sequentially transmitted to the remote site by using a line among sites. If there is a sufficient line band (data transmission capacity), the quantity of data collected in the side file does not increase. However, if the line band is set to be small, data not transmitted to the remote site is collected in the side file.

In order to prevent the remote copy operation from being disabled due to the generation of update data overflowing the capacity of the side file, when the utilization of the side file exceeds a predetermined threshold, the method of remote copy using the side file is interrupted and changed over to a method using the differential copy described later.

Next, a logical volume constructed in the storage device in the main site will be described. In the case where the database is handled as a storage object, the logical volume is composed of a logical volume for holding data itself and a logical volume for holding log data which is a record about database update.

Here, attention is paid to the utilization of the side file. That is, if the utilization of the side file increases (second threshold), transmission of updated data of a logical volume other than the logical volume of the log data, that is, the logical volume for holding data itself, is interrupted.

When the utilization of the side file at which the data transmission of a logical volume for holding data itself is interrupted is set low while the utilization of the side file at which the data transmission of a logical volume for the log data is interrupted is set high, even if data update exceeding a data transmission line band occurs in the main site, the data transmission of the entire database is not interrupted but only the transmission of data other than the log data is interrupted. Consequently, the log data is always transmitted to the remote site and data recovery in a remote site at the time of disaster is enabled by using the log data even in a minimal line band.

Further, by applying automatic restart function of data transmission to the present invention, the interrupted data transmission other than the log data is automatically restarted and data consistency at a quiescent point can secured, and thus, the disaster recovery system can be established.

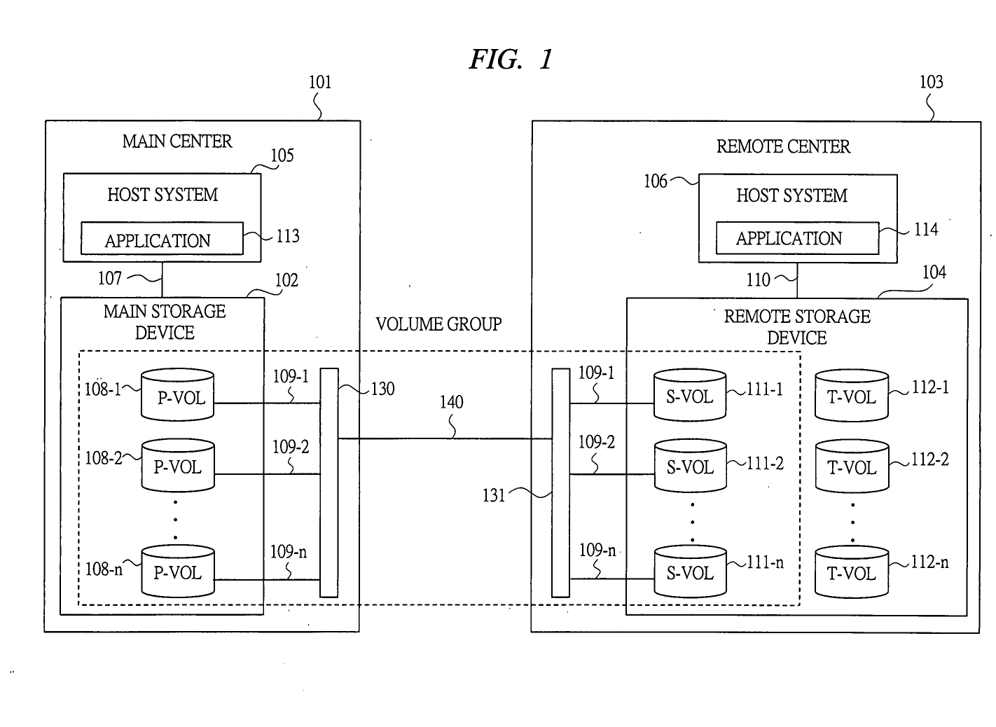

As shown in FIG. 1, there are usually several logical volumes for holding the database data and log data. A group constituted of the plural logical volumes is called consistency group. The order of data update carried out by the database is maintained in this consistency group.

According to the present invention, the logical volumes which constitute this consistency group are further classified to a logical volume group for holding the log data and a logical volume group for holding other data so as to control the data transmission.

Hereinafter, the embodiment of the present invention will be described in detail with reference to the drawings. However, the present invention is not limited to the following description.

<Entire Structure of Remote Copy System>

An example of the entire structure of the remote copy system according to an embodiment of the present invention will be described with reference to FIG. 1. FIG. 1 is a block diagram showing the entire structure of a remote copy system according to an embodiment of the present invention.

In the remote copy system of this embodiment, as shown in FIG. 1, data is duplicated between two data centers, that is, a main center 101 installed in the main site and a remote center 103 installed in the remote site. The main center 101 is provided with a main storage device 102 and a host system 105 connected thereto. The remote center 103 is provided with a remote storage device 104 and a host system 106 connected thereto.

The main storage device 102 in the main center 101 and the remote storage device 104 in the remote center 103 are connected not through the host systems 105 and 106 in the both centers so as to realize the remote copy system in which data possessed by the main storage device 102 is duplicated in the remote storage device 104.

In the main center 101, the main storage device 102 is connected to the host system 105 having CPU which executes data processes such as reference and update to the main storage device 102 through an interface cable 107. This host system 105 is provided with various kinds of applications 113 such as database.

Also, the main storage device 102 includes a plurality of primary logical volumes (P-VOL) 108 (108-1, 108-2, . . . 108-n) which store the data for executing processes such as reference and update from the host system 105.

On the other hand, the remote storage device 104 in the remote center 103 is connected to the host system 106 having the CPU through an interface cable 110. This host system 106 is provided with various kinds of applications 114 such as database.

This host system 106 can be a substitute of the host system 105 when the host system 105 of the main center 101 cannot exert its own function due to disaster or trouble. Further, this host system 106 can execute a process different from the host system 105 of the main center 101 by using the data stored in the remote storage device 104 in such cases other than disaster and trouble.

In addition, the remote storage device 104 includes a plurality of secondary logical volumes (S-VOL) 111 (111-1, 111-2, . . . 111-n) which store the data for executing reference and update processes from the host system 106 and target volumes (T-VOL) 112 (112-1, 112-2, . . . 112-n).

When a data write instruction is transmitted to the P-VOL 108 possessed by the main storage device 102 from the host system 105 in the main center 101, data is transmitted to the S-VOL 111 possessed by the remote storage device 104 in the remote center 103 through respective interface cables 109 (109-1, 109-2, . . . 109-n) corresponding to each P-VOL 108 and each S-VOL 111.

Note that at least one of the plurality of primary logical volumes (P-VOL) 108 is a log logical volume for holding update information (log data) of database provided by an application software.

Likewise, each of the secondary logical volume (S-VOL) 111 and the target logical volume (T-VOL) 112 has a log logical volume corresponding to the log logical volume of the primary logical volume.

Write data transmitted from the interface cable 109 is multiplexed by a line multiple separation/public network interface (I/F) section 130 having the line multiple separation function and compatible with a public network on the way and transmitted to the S-VOL 111 through a specific public line 140 on the public network. More specifically, in the copy process of write data to the S-VOL 111, all write data pass through this public line 140.

Therefore, when a large traffic is applied to this public line 140 at a time, this section becomes a bottleneck. In the meantime, the line multiple separation public network I/F section 130 may be connected to the interface cable 109 one to one.

According to this embodiment, the utilization of a side file at which the data transmission is interrupted is set in advance for each small group obtained by classifying the consistency group. Therefore, even if a large traffic is applied to this public line 140 at a time, the priority order of the small group is determined so that important data can be always transmitted to a remote site without stopping the data transmissions of all logical volumes in the consistency group of the logical volumes which control the data update order. Its detail will be described later.

<Structure of Storage Device>

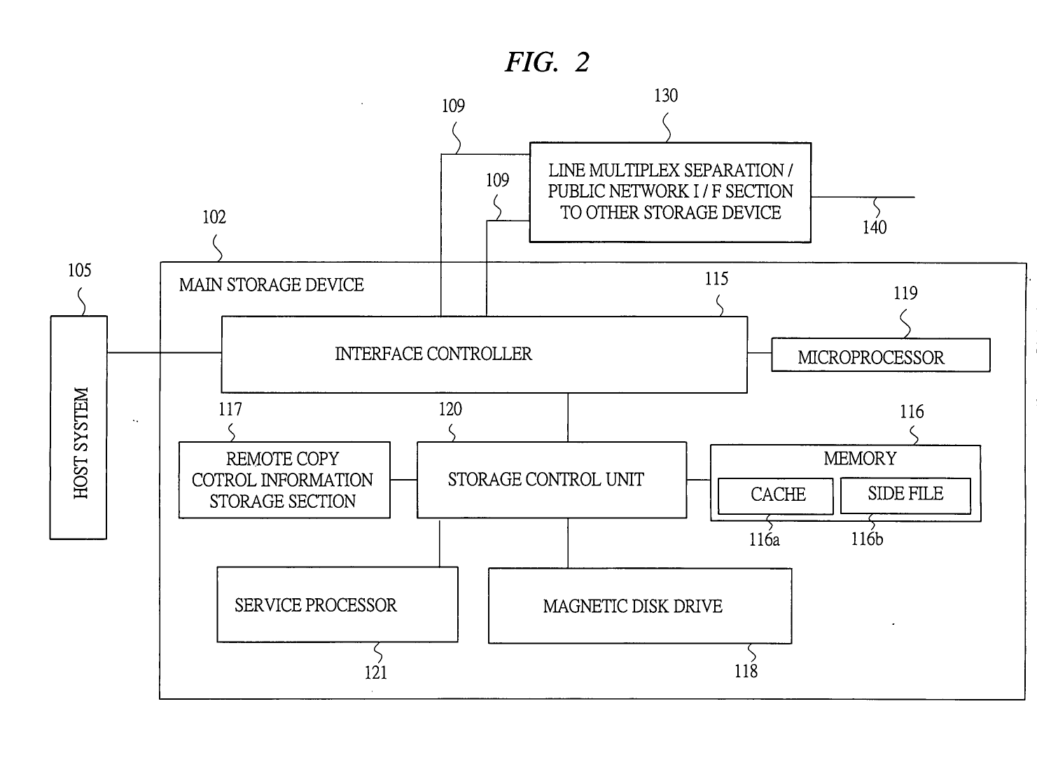

An example of the internal structure of the storage device will be described with reference to FIG. 2. FIG. 2 is a block diagram showing the internal structure of the storage device. FIG. 2 shows the main storage device 102, and description of the remote storage device 104 will be omitted because it has the same internal structure.

The main storage device 102 comprises an interface controller 115 for exchanging data with the host system 105, a memory 116 for temporarily storing data referenced or updated by the host system 105, a remote copy control information storage section 117 for storing information concerning the storage location of updated data when the remote copy is being interrupted, a magnetic disk drive 118 which is a recording medium for recording data of the host system 105, a microprocessor 119 for controlling the data exchange, a storage control unit 120 which exchanges data with the magnetic disk drive 118 and controls these components, and a service processor 121 which monitors the state of the remote copy and enables the user to set under what settings the remote copy is carried out.

The memory 116 includes a cache 116a which stores the referenced or updated data and a region for storing a side file 116b of data transmission cache. The side file 116b stores information for data transmission including data to be transmitted and information concerning data storage location and update order.

The magnetic disk drive 118 in the main storage device 102 has a plurality of P-VOLs 108 shown in FIG. 1 which store the data for reference and update process from the host system 105. The magnetic disk drive 118 in the remote storage device 104 has a plurality of S-VOLs 111 and T-VOLs 112 shown in FIG. 1.

Further, the main storage device 102 in FIG. 2 includes an interface controller 115 for exchanging data with the remote center 103. The interface cables 109 shown in FIG. 1 are connected from this interface controller 115. These interface cables 109 are connected to the line multiple separation public network I/F section 130.

The line multiple separation public network I/F section 130 transmits the data received from each interface cable 109 to the line multiple separation public network I/F section 131 of the remote center 103 through the public line 140. The line multiple separation public network I/F section 131 on the side of the remote center 103 is connected to the interface controller 115 in the remote storage device 104 through the interface cable 109.

In this configuration, when the remote copy is carried out to the remote center 103 from the main center 101, data transmission is enabled through different communication paths corresponding to each logical volume in the respective storage devices 102 and 104. In the public network, however, the communications to all the logical volumes are carried out on a single public line 140, and loads of data transmission are concentrated thereon.

As the interface cable 109 for connecting between the centers, for example, an optical fiber link driven by a LED driver unit or an optical fiber cable is used, and generally, the interface cable 109 is driven according to an interface protocol called fiber channel.

The public line 140 is an electric communication link represented by T3 network and ATM network, and the line multiple separation public network I/F section 130 is a data transmitter capable of extending the connection distance of the interface represented by a channel extender and a fiber channel switch.

Therefore, it is permissible to connect an ordinary fiber channel or T3 network on the way between the main storage device 102 and the remote storage device 104.

In the main storage device 102 and the remote storage device 104 connected in the above-described manner, particularly the service processor 121 has a function to set the utilization of the side file 116b at which the data transmission of the logical volume other than the log data is interrupted. Various kinds of information (such as threshold) set up by this service processor 121 is stored in the remote copy control information storage section 117.

Also, the microprocessor 119 monitors the quantity of data collected in the side file 116b and if the quantity of data collected in the side file 116b exceeds a threshold as a result of this monitoring, data transmission of the logical volumes other than the log data is stopped.

Here, the consistency group of the logical volume will be described. When database having a large capacity is handled, a plurality of logical volume are required in some cases. Further, under a recent trend of huge scale of the database, the logical volume for holding the log data is sometimes constituted of plural logical volumes.

This point will be described with reference to FIG. 1. In the case where, of the plural primary logical volumes 108-1 to 108-n, for example, the P-VOL 108-1 and P-VOL 108-2 are the primary logical volumes for holding the log data of the database and other volumes up to P-VOL 108-n are set as the primary logical volumes for handling the data of the database, these plurality of primary logical volumes need to be data having a uniform meaning. However, depending on the transmission condition of the communication line by the interface cables 109-1 to 109-n, actually, data of the primary logical volume updated latter is transmitted to the public line 140 ahead of the data of the primary logical volume updated former.

As a result, data of the primary logical volume updated latter can be transmitted to a corresponding secondary logical volume earlier than the data of the primary logical volume updated former. Under such a condition, the secondary logical volume of the remote center 103 becomes asynchronous with the update progress of the database. If a trouble occurs on the side of the main center 101 under such a condition, data is lost completely in the worst case.

In such an asynchronous remote copy system, a logical volume group which needs to maintain the consistency is called consistency group. And also on the side of the remote center 103, data update is controlled so as to be carried out in the same order that the host system 105 updates its data by, for example, attaching sequence numbers to the write I/O. As for the other method, the control method in which the consistent state is secured for each timing and the state is held in the target logical volume of the remote center 103 is also available.

Generally, this consistency group is constructed to include a logical volume for holding the log data of the database. According to the presented invention, this consistency group is classified to the logical volume of log data and the logical volume of data other than the log data in order to control the remote copy.

According to a preferred embodiment, the line band of the public line 140 is not set to a size estimated for the case where the data transmission becomes most frequent but to a band in which the data transmission is less frequent. When the utilization of the side file reaches a certain threshold, transmission of a logical volume which constitutes data having much information amount other than the log data is interrupted and only the logical volume of the log data is transmitted. The reason is that if the remote storage device 104 of a remote site can receive just the log data, data can be updated up to its latest state by reflecting the log data on the data already received by the secondary logical volume 111.

Further, the microprocessor 119 has a function to restart data transmission of the logical volume which constitutes the data other than the log data whose transmission is interrupted when the quantity of data collected in the side file 116b becomes less than the threshold as a result of the monitoring. Further, the microprocessor 119 has a function to restore the database by using the log data and the data other than the log data in the remote site when disaster occurs.

<Duplication by Copy Function>

The main storage device 102 shown in FIG. 2 included in the remote copy system shown in FIG. 1 controls ordinary reference and update processes to the P-VOL 108 possessed by the main storage device 102 from the host system 105 and copy of data in the P-VOL 108 to the S-VOL 111 possessed by the remote storage device 104. This remote copy control is executed by the microprocessor 119. Of course, it is needless to say that this control can be executed by a microprocessor (not shown) provided in the storage control unit 120.

More specifically, the main storage device 102 is so constructed that the P-VOL 108 and the S-VOL 111, which is a copy object, make a pair. The configuration of pair logical volume is controlled so that, for example, the P-VOL 108-1 and the S-VOL 111-1 make a pair and the P-VOL 108-2 and the S-VOL 111-2 make a pair. Also, the copy execution state (status) of pair logical volume is controlled. The remote storage device 104 controls execution of write of data transmitted from the main storage device 102, and the configuration and status of the pair logical volume.

The status mentioned here refers to a state of copy execution between the P-VOL 108 and the S-VOL 111 and includes three states such as “duplex”, “duplex pending” and “suspend”. “Duplex” means a state of duplex in which the P-VOL 108 and the S-VOL 111 maintain a pair relation, in other words, the state in which the update process of the P-VOL 108 is sequentially reflected on the S-VOL 111. “Duplex pending” means a state not the duplex state but the state in which differential data is being transmitted although copy is made from the P-VOL 108 to the S-VOL 111. “Suspend” means a state in which the process for reflecting update data of the P-VOL 108 on the S-VOL 111 is interrupted while maintaining the pair relation.

These statuses can be changed by a command issued to a pair logical volume from the applications 113 and 114 in the host systems 105 and 106 or the service processor 121 in the storage devices 102 and 104 and an application in a console connected directly to the storage devices 102 and 104 through LAN.

According to this embodiment, a logical volume group for holding consistency of data content is pair logical volume of the P-VOL 108 and S-VOL 111. Consequently, when the pair logical volume is in the status of duplex, the update order of the P-VOL 108 and the update reflection of the S-VOL 111 are matched with each other to hold the consistency of data content in the P-VOL 108 and S-VOL 111.

Further, the T-VOL 112 possessed by the remote storage device 104 of this embodiment is a logical volume group which stores a duplicate of the S-VOL 111 at the time when all pair logical volumes of the P-VOL 108 and S-VOL 111 defined as a logical volume group are in the state of suspend.

Although not described in detail here, the technology for creating a duplicate of the S-VOL 111 in the T-VOL 112 of this embodiment is the technology for duplicating data between storage devices by the remote copy function. On the other hand, this creation technology can use a technology for duplicating data in the same storage device.

With this configuration, data in the S-VOL 111 can be duplicated in the T-VOL 112 while using the S-VOL 111 and the T-VOL 112 in the same storage device as paired logical volumes.

<Detail of Remote Copy>

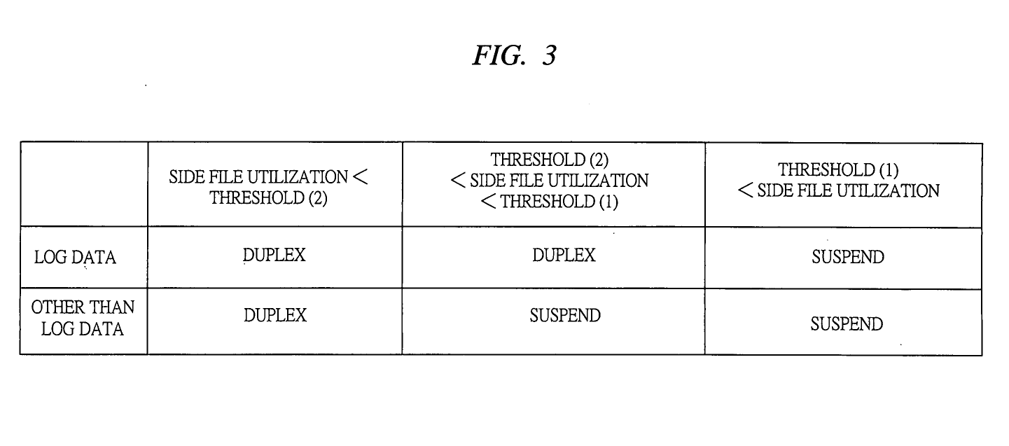

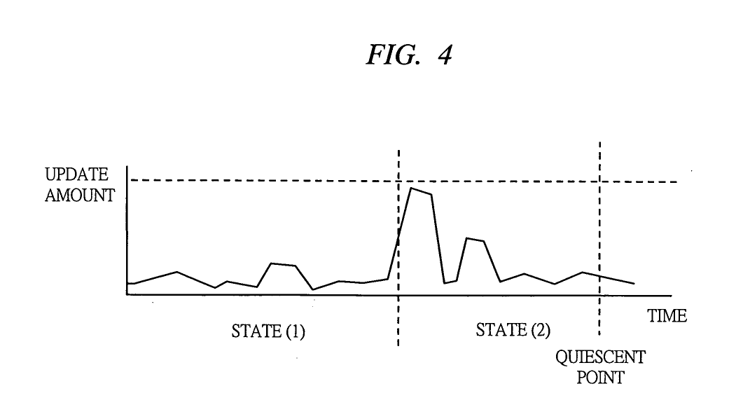

The remote copy of this embodiment will be described further in detail with reference to FIGS. 3 and 4. FIG. 3 is an explanatory diagram showing the pair status of the logical volume with respect to the utilization of the side file of the log data of the logical volume and the data other than the log data. FIG. 4 is an explanatory diagram showing the change of data update amount in a database in a daily operation. The present invention will be described further in detail.

In the remote copy system, entire database is registered in a single consistency group in order to secure the consistency of data in the entire database in the main site, and the consistency group is classified to two small groups. One of them is a small group of the logical volume of the log data and the other one is a small group of the logical volume of the data other than the log data. Then, a threshold of the utilization of the side file 116b is set for each small group, and if the utilization exceeds this threshold, each small group interrupts data transmission to the remote site.

When the threshold of the log data is set as a first threshold (1) and the threshold of the data other than the log data is set as a second threshold (2) while the threshold (2) is smaller than the threshold (1), the pair status of the logical volumes with respect to the utilization of the side file of a small group of each logical volume is as shown in FIG. 3.

More specifically, as shown in FIG. 3, the small group of the logical volume of the log data becomes the duplex status when the utilization of the side file<the threshold (2) and the threshold (2)<utilization of the side file<threshold (1), and becomes suspend status when the threshold (1)<utilization of the side file. Also, the small group of the logical volume of data other than the log data becomes the duplex status when the utilization of side file<the threshold (2) and becomes the suspend status when the threshold (2)<utilization of the side file<the threshold (1) and the threshold (1)<utilization of the side file.

As for actual operation, in a database in which the update amount increases temporarily in daily operation as shown in FIG. 4, the entire database is transferred to the remote site at the time of state (1) and only the data log is transferred to the remote site at the time of state (2). Consequently, if a trouble occurs, the system can be recovered from that trouble based on the data log. The time when the daily operation ends is a quiescent point.

Consequently, it is possible to establish a system capable of coping with a sudden increase in data without contracting to use any data transmission line in consideration of a peak value at a temporary data update. However, when such an operation is carried out, the state (2) happens temporarily and the data transmission of data other than the log data is interrupted. In such a case, since a function to automatically restart the data transmission is necessary, it is necessary to apply the automatic restart function for data transmission described later so as to secure the data consistency.

In the data transmission to the remote site, it is possible to pay attention to not only the data update amount of the database, that is, the quantity of data collected in the side file 116b but also the quantity of data transmission on the public line 140. In the case where attention is paid to the quantity of data transmission on the public line 140, this system can be realized by providing the means for recognizing the specifications of the compression in the public line or the line multiple separation public network I/F section by using a storage device.

<Automatic Restart Function of Data Transmission>

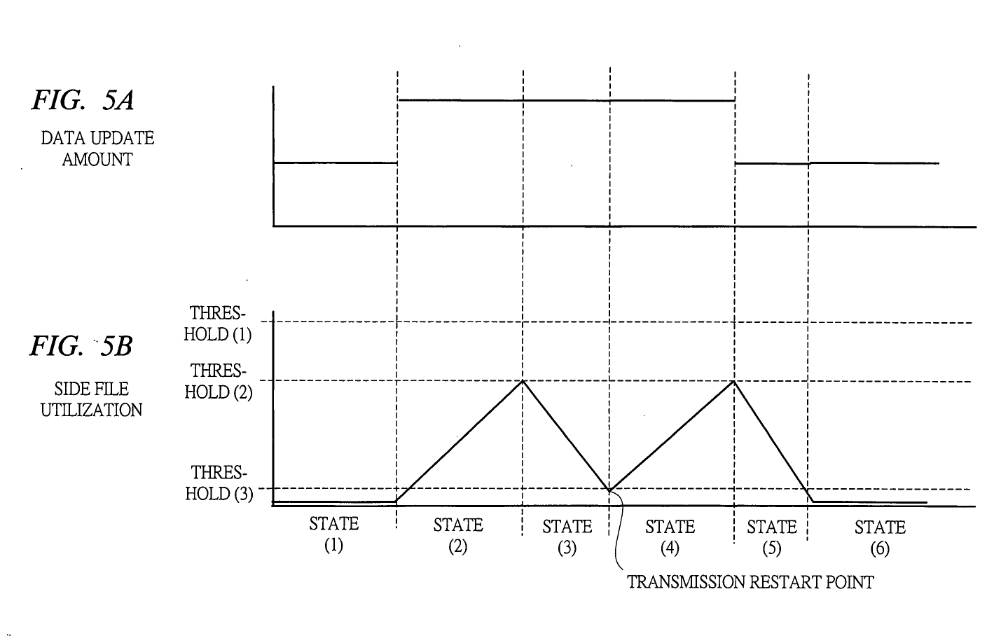

An example of the automatic restart function of data transmission will be described with reference to FIG. 5. FIG. 5 is an explanatory diagram showing the automatic restart function of data transmission, in which FIG. 5A shows the changes in quantity of data update in database in daily operation and FIG. 5B shows the changes in the utilization of the side file.

According to this embodiment, even if an unexpected data update occurs, transmission of the log data of the database is continued. Thus, even if a disaster occurs, the database can be recovered in the remote site. However, because data other than the log data is not transmitted, it is necessary to restart the transmission of the data other than the log data whose transmission is interrupted. Thus, the automatic restart function of data transmission is applied to secure the data consistency.

As shown in FIG. 5, a third threshold (A) of the utilization of the side file is set. This threshold (A) is a value which is set to a lower value than the threshold (1) and the threshold (2). When the utilization of the side file drops below this threshold (A), the main storage device 102 of the main center 101 transmits updated data of a period, in which the data transmission is interrupted, to the remote center 103.

Here, the status of the duplex in FIG. 3 will be described in detail.

When the logical volumes (P-VOL and S-VOL) of the main site and remote site are set as a pair, the write process performed to the P-VOL in accordance with the state (status) of the pair induces the start of various processes for the S-VOL. The state (status) of the pair includes suspend state, duplex state, and initial copy state, and when the state (status) of the pair is duplex, a process in which data written into a main logical volume is written into a sub logical volume is carried out. Also, in the suspend state, data written into the main logical volume is not reflected on the sub logical volume but the location information of the updated part is held in the main storage device 102 by using a differential bit map.

That is, when the transmission of data part is once interrupted by the suspend, the data location information updated in the period of that interruption is held in a memory (called bit map) in the main storage device 102. Thereafter, by referencing the bit map before the pair state is established again, only data at an updated part is read from the cache 116a and transmitted to the remote storage device 104 in the remote site. Because the transmission in this case holds no update order, if any trouble occurs in this transmission, data in the logical volume of the remote storage device 104 loses the consistency, and it cannot be recovered completely (consistency with the log information in the database is not secured).

For its prevention, as shown in FIG. 1, a logical volume (T-VOL 112-1 to 112-n) paired with the logical volume (S-VOL 111-1 to 111-n) on the side of the remote site is held in the remote storage device 104 so as to hold a state in which the S-VOL maintains the consistency. This point has been described in detail in the above-mentioned Japanese Patent Application Laid-Open No. 2002-189570 (content of which is incorporated in the present invention).

In the remote copy system in which the data update shown in FIG. 4 occurs, when the state (1) is below the threshold (2) in FIG. 4, all update data and log data of the database are transmitted.

The situation in this case will be described with reference to FIG. 5. A graph indicating the quantity of data update in FIG. 5A indicates an average quantity of data update in each certain period. When the quantity of data update is low like in the state (1) in FIG. 5 (state (1) in FIG. 4), the utilization of the side file is also low (state (1) in FIG. 5).

Then, when the data update reaches a peak like state (2) in FIG. 4, the utilization of the side file increases gradually (state (2) in FIG. 5) and when it exceeds the threshold (2), transmission of data other than the log data is interrupted although the transmission of the log data is continued (border between the state (2) and state (3) in FIG. 5).

Because the quantity of updated data to be transmitted decreases when transmission of data other than the log data is interrupted, the utilization of the side file is reduced gradually (state (3) in FIG. 5). Then, when the utilization of the side file is less than the threshold (A) (restart point in FIG. 5), the transmission of data other than the log data whose transmission is interrupted is restarted (state (4) in FIG. 5).

This point will be described in detail. When the utilization of the side file returns to a low level indicated by the threshold (A) in FIG. 5B, it is preferable to use the band of communication line effectively by restarting the transmission of the data other than the log data. However, because transmission of data other than the log data is stopped (a pair is suspended) at the time when the utilization of the side file reaches the threshold (2) in the state (2) in FIG. 5, data in the remote site needs to be restored to the data just when it was suspended. At the same time, accumulation of update data in the side file is started.

The data transmission in this case is carried out by transmitting data at a location corresponding to an update region held in the bit map as described above. During the transmission of this updated data, the data transmission is not executed in accordance with the update order to the database. Therefore, in such a period, the S-VOL and T-VOL in the remote storage device 104 need to be in the state of suspend as described later. This T-VOL makes it possible to maintain the state that the database is updated in accordance with its update order. It is needless to say that, after a data transmission period in which this update order is not maintained ends, the S-VOL and T-VOL are paired again.

When the S-VOL becomes unavailable because of any trouble during the data transmission period in which this update order is not maintained, the data with consistency can be obtained again in the remote site by updating the data image of this T-VOL by using the log data.

Thereafter, transmission of data accumulated in the side file is started and the remote storage device 104 updates the S-VOL by using that data. That is, by this restarted data transmission, interrupted update data is also transmitted, and if all transmission is completed by the quiescent point in daily operation, it is possible to continue the disaster recovery operation.

Preferably, when the utilization of the side file exceeds the threshold (1), the transmission of the log data as well as the data other than the log data is interrupted, and when the utilization of the side file decreases, the interrupted data transmission is restarted in the order of the log data and the data other than the log data. A restart point for data transmission of the log data is, for example, a fourth threshold between the threshold (A) and the threshold (2). Also in this case, the interrupted data, that is, the log data and the data other than the log data are controlled by the differential bit map and the differential data on the bit map is transmitted first prior to the restart as described above.

These functions are achieved by a microprogram for specifying the control of the microprocessor. A microprocessor 119 of the main storage device 102 and a microprocessor of the storage control unit 120 execute the above-described control according to this microprogram.

<Data Recovery Method in Remote Site>

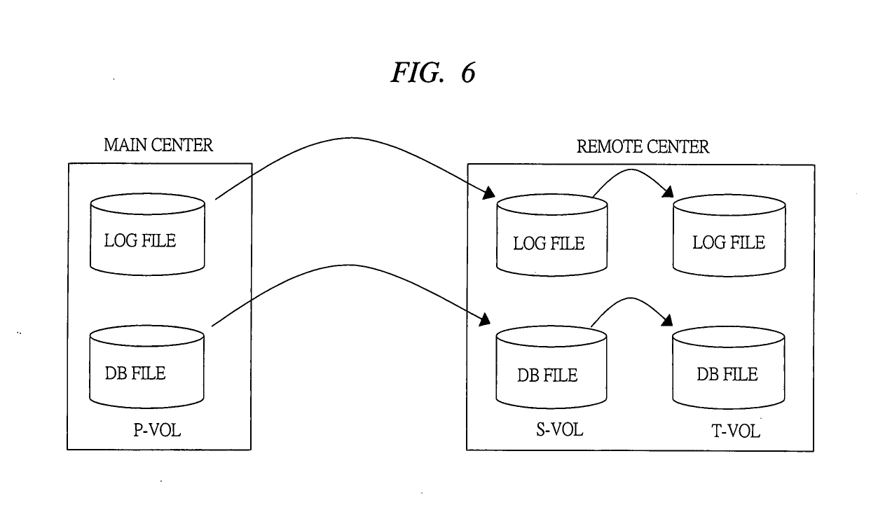

An example of the data recovery method of the remote storage device 104 will be described with reference to FIG. 6. FIG. 6 is an explanatory diagram showing the case for creating the logical volumes of the log data and the data other than the log data.

According to this embodiment, as shown-in FIG. 6, by managing the logical volumes constituting the P-VOL 108, S-VOL 111, and T-VOL 112 by classifying them to logical volumes (logical unit: LU) of files of the log data (LOG) and logical volumes (logical unit: LU) of files of data (DB) other than the log data, the data part of data other than the log data in the S-VOL 111 of the remote storage device 104 can be recovered even if data other than the log data cannot be transmitted.

First, the case where any trouble occurs under the condition that only a logical volume for accumulating the data part of data other than the log data is in the state of suspend will be described. The contents of the LOG file comprises (1) log sequential number (including time), (2) type of log record, (3) log about state/content before update, (4) log about state/content after update, and (5) additional information. The T-VOL 112 on the side of the remote center 103 is updated with these contents of the log data. This process can be carried out by using a control unit of the remote storage device 104, and may be carried out in the following manner. That is, the host system in the remote site reads log data and then database application of the host system issues a command corresponding to that log data to the S-VOL 111 of the remote storage device 104.

On the other hand, if any trouble occurs when the P-VOL 108 and the S-VOL 111 for accumulating the log data part are in the state of suspend, data of the S-VOL 111 can be recovered as required by using the log data of the T-VOL 112 in the remote storage device 104. The reason why the condition as required is specified here is that data capable of recovering the data by using the log data in the T-VOL 112 may be already possessed by the data part other than the log data of the T-VOL 112. In this case, that process is not necessary.

The data recovery process is executed by repeating the procedure for rewriting the content of the log, (1) in the order of the sequential number of log data, (3) while verifying a log about the state/content before the update, and (4) to the log about the state/content after the update.

In any case, data recovery is carried out by using the data and log file with consistency. Therefore, the clear timing of the log file is the backup timing, and any problem does not occur in the operation.

Following four cases can be considered as a data recovery method for the case where a trouble actually occurs, and will be sequentially described. In these cases, the host system connected to the remote site and main site is constructed so as to carry the information of jobs completed in the main site over the remote site through the communication therebetween (fail-over function).

(1) Case 1

In the case where a trouble occurs in the main site during the transmission when both the P-VOL accumulating the LOG file and the P-VOL accumulating the DB file maintain the pair relation, copy from the P-VOL 108 to the S-VOL 111 is interrupted. Because data in the S-VOL 111 has consistency in this case, it is copied to the T-VOL 112 in the storage device 104 and recovery process for the database is carried out by using the function of database application in the host system 106. Data in the DB file is updated by using the log data in the T-VOL 112 and a checkpoint function of the database. Consequently, the process which has been executed by the database application until just before the trouble occurs is reproduced to recover database constructed in the T-VOL 112.

(2) Case 2

In the case where a trouble occurs in the main site when only the data transmission of the DB file is interrupted because the quantity of transmission of data from the P-VOL 108 to the S-VOL 111 is large, the copy of the LOG file from the P-VOL 108 to the S-VOL 111 is interrupted. In this situation, no latest DB file exists although latest LOG file exists. However, since the T-VOL 112 has a DB file at a previous quiescent point, after copying the LOG file of the S-VOL 111 to the LOG file of the T-VOL 112, the database is recovered by using the LOG file and the DB file in the T-VOL 112 by the function of database application in the host system.

(3) Case 3

In the case where the quantity of data transmitted from the P-VOL 108 to the S-VOL 111 is large, after only the data transmission of the DB file is interrupted, copy is restarted by the automatic restart function of data transmission. However, if a trouble occurs in the main site when the copy does not ensure the order of update using the side file and differential data in the bit map is being transferred, copy of the LOG file from the P-VOL 108 to the S-VOL 111 is interrupted. Because the DB file of the S-VOL 111 does not have consistency in this case like in the case 2, the database is recovered by using the method of updating the T-VOL 112 in the same manner as the case 2.

(4) Case 4

In the case where any trouble occurs when transmission of both of the LOG file and the DB file is interrupted because the quantity of data transmitted from the P-VOL 108 to the S-VOL 111 is large, or in the case where any trouble occurs in the main site when copies of the LOG file and the DB file are both the differential copy although the copy is restarted by the automatic restart function for data transmission, the database is recovered by using the LOG file and DB file of the T-VOL 112 since the LOG file and DB file in the S-VOL 111 do not have the consistency.

However, in the case where a trouble occurs in the main site under the condition that copy is intentionally carried out at the quiescent point, data of the LOG file and DB file in the S-VOL 111 is copied to the T-VOL 112 and used as a database because the LOG file and DB file in the S-VOL 111 have the consistency.

<Setting Method of Data Transmission Function>

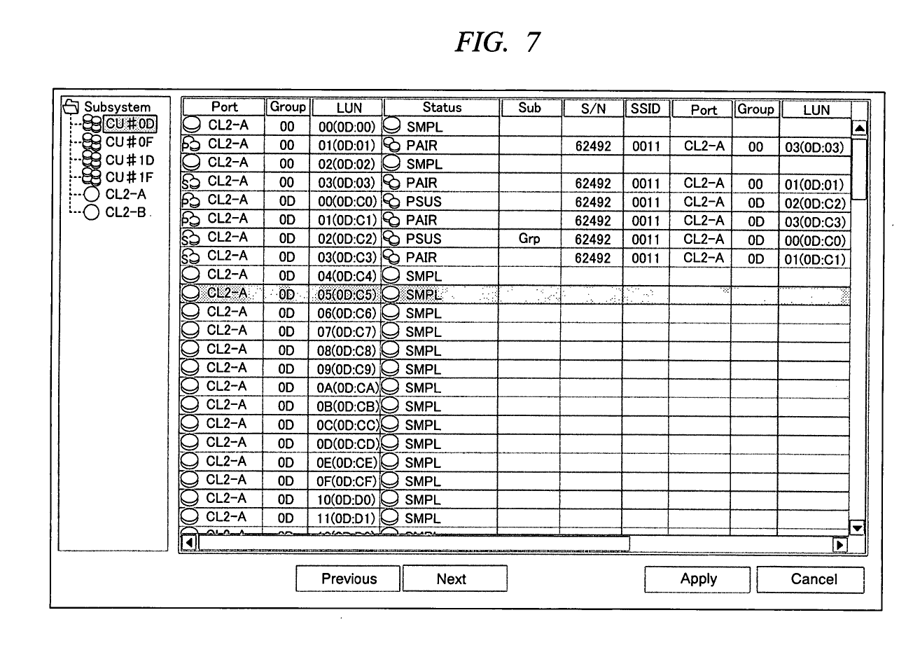

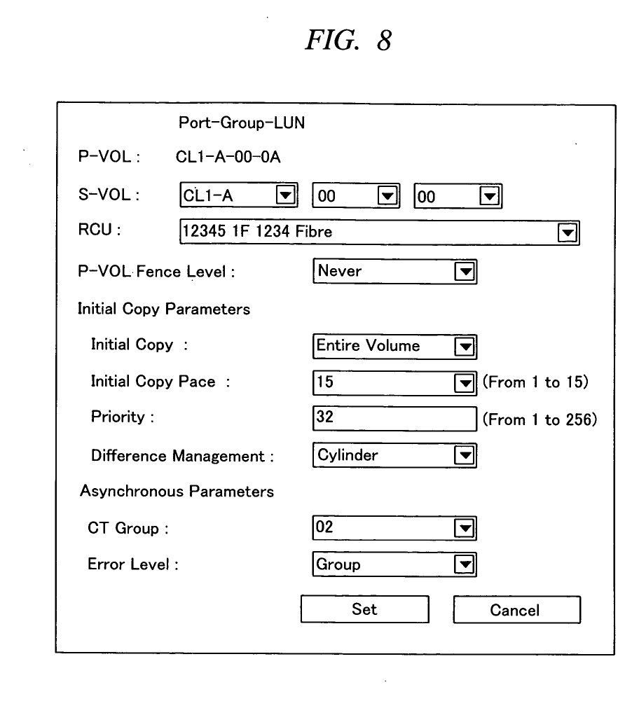

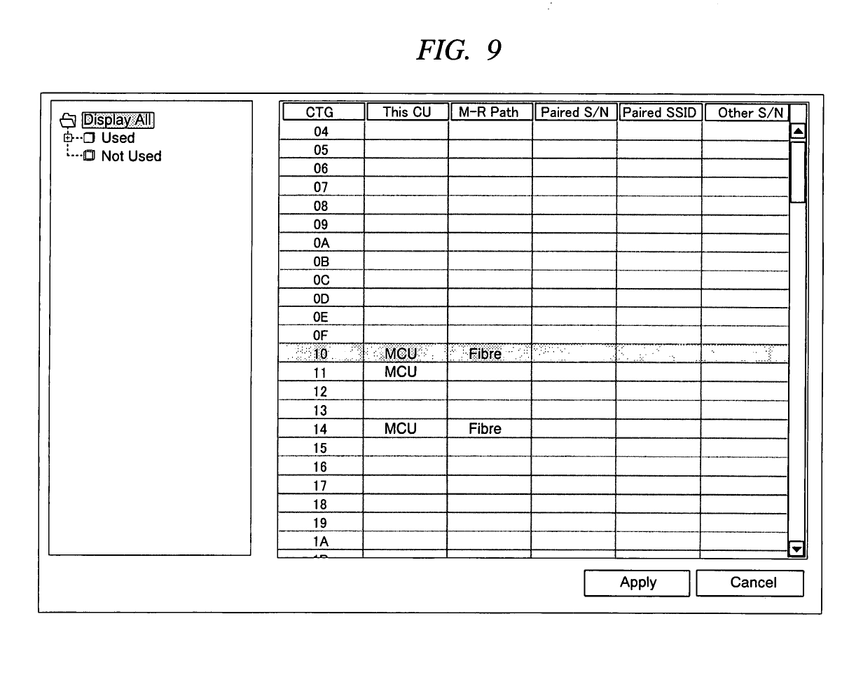

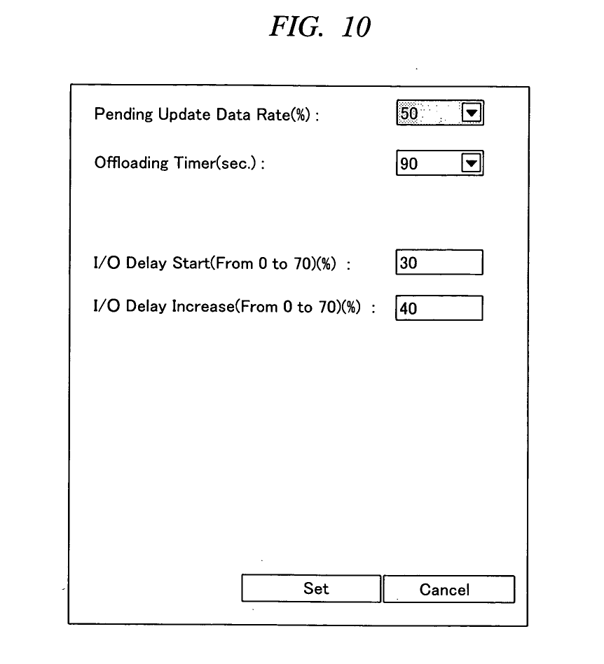

An example of the setting method of data transmission function will be described with reference to FIGS. 7 to 10. FIG. 7 is an explanatory diagram showing the case of selecting a LU desired to be set in accordance with the setting method of the data transmission function. FIG. 8 is an explanatory diagram showing the case of setting the copy destination VOL and the consistency group. FIG. 9 is an explanatory diagram showing the case of selecting a consistency group to be set. FIG. 10 is an explanatory diagram showing the case of setting the procedure of the side file.

According to this embodiment, the setting of the data transmission function of a storage device is carried out by the service processor 121 of FIG. 2.

More specifically, a LU desired to be set is selected in the screen of FIG. 7. In the example of this screen, the LU having the port of CL2-A, the group of OD, and the LUN (logical unit number) of 05 (OD: C5) is selected from CU#OD in the storage device.

Further, by displaying the screen of FIG. 8 from a pop-up menu in FIG. 7, a copy destination VOL and a consistency group are set. In the example of this screen, CL1-A is set as the S-VOL of copy destination to CL1-A-00-OA of the P-VOL which is a copy object and 02 is set as CT group.

Further, a small group in the consistency group is set. At this time, the threshold of a side file when the small group is suspended is set. In this setting of the consistency group, a consistency group to be set is selected from a list of the consistency group (CTG) of FIG. 9. In the example of this screen, CTG 10 is selected.

As for the detailed setting of the small group, the procedure of the side file is set on the screen of FIG. 10. In the example of this screen, 50% is set as the pending update date rate, 90 sec is set as the offloading timer, 30% is set as the I/O delay start, and 40% is set as the I/O delay increase.

<Control on Remote Data Transmission>

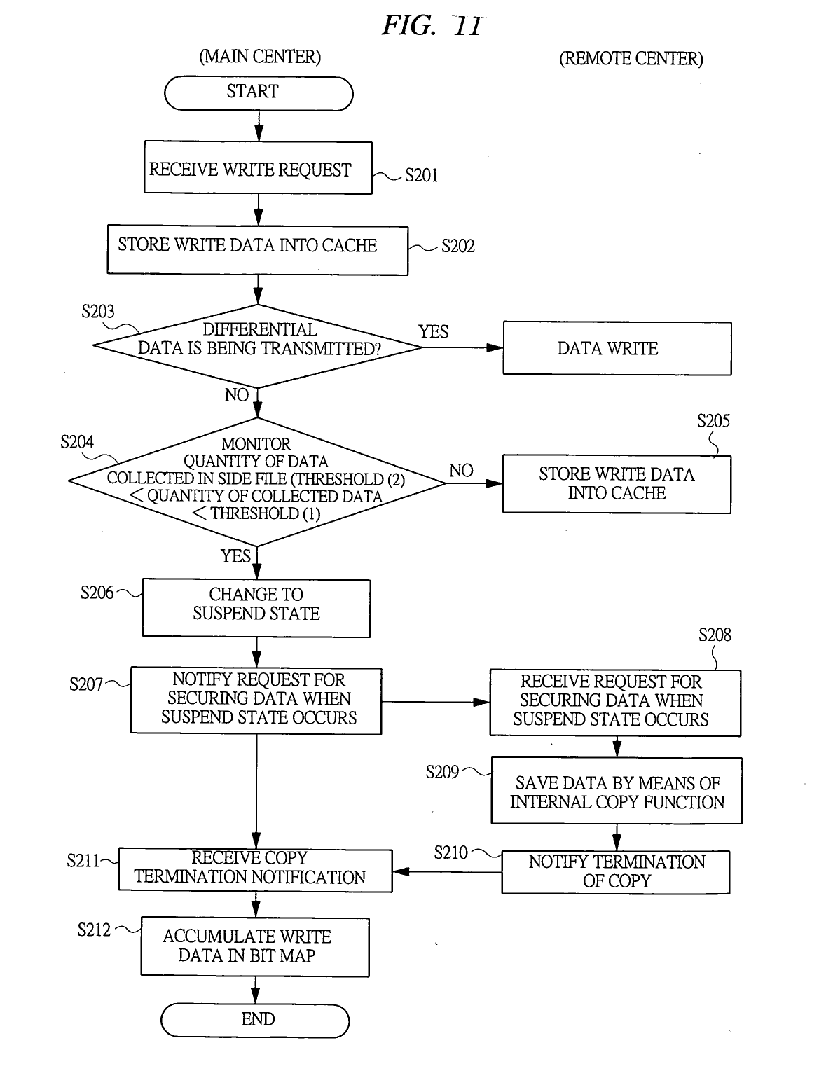

An example of the control method of remote data transmission will be described with reference to FIG. 11. FIG. 11 is a flow diagram showing the control method of the remote data transmission.

The control of the remote data transmission is started when the main storage device 102 receives a write request command from the host system 105.

More specifically, in the main storage device 102, the interface controller 115 receives a write data request from the host system 105 (S201). Then, the received write data is stored in the cache 116a (S202). Note that when data is stored in the cache 116a, data storage is ensured and this data is stored in the P-VOL 108 through the storage control unit 120.

Next, the storage control unit 120 of the main storage device 102 determines whether or not this system is transmitting data in accordance with the differential data transmission method (S203). The process in the case where the data is being transmitted in accordance with the differential data transmission method as a result of the determination step (YES) will be described later.

If no data transmission is being executed (NO) as a result of determination in S203, the log data is accumulated in the cache 116a based on a write command received in S201. This log data and write data are accumulated in the side file 116b for data transmission and the quantity of collected data (utilization of the side file) is monitored by the microprocessor 119 connected to the interface controller 115 (S204).

When the quantity of collected data is smaller than the threshold (2) shown in FIG. 4 (NO), the log data and the data other than the log data are sequentially transmitted to the remote storage device 104 in the remote center 103 and are duplicated therein, and written into the cache 116a in the remote storage device 104 (S205). The transmission in this case is not always carried out immediately after data is received, and after temporarily accumulating the data in the side file 16b, the data is sequentially transmitted according to the accumulation order as long as the band of the communication line permits. Naturally, when the update data increases, the data collected in the side file 116b increases gradually. That is, the utilization of the side file 116b is increased.

In the remote storage device 104, the data received through the side file 116b is temporarily held in the cache 116a and stored in the S-VOL 111 in the same manner as the write into the P-VOL 108 of the main storage device 102. In any case, update data is sequentially accumulated in the side file 116b as long as the pair state of the P-VOL 108 and the S-VOL 111 is in the duplex state.

If the microprocessor 119 determines that the quantity of data collected (utilization of the side file) in the side file 116b is larger than the threshold (2) and smaller than the threshold (1) shown in FIG. 4 (YES), the storage control units 120 in the main storage device 102 and the remote storage device 104 change the pair state of the P-VOL 108 and S-VOL 111 holding data other than the log data from the pair state to the suspend state (S206). Also in this case, data transmission in the side file 116b is continued. However, when the state of the P-VOL 108 and S-VOL 111 is changed to the suspend state, no update data is accumulated in the side file 116b but only updated location information is held in the bit map of the main storage device 102.

Then, the storage control unit 120 in the main storage device 102 notifies the remote storage device 104 of a request for securing data when suspend state occurs (S207). The storage control unit 120 in the remote storage device 104 which receives this request for securing data changes the S-VOL 111 and T-VOL 112 accumulating the data other than the log data to the suspend state (S208, S209).

The S209 will be described. The S-VOL 111 and the T-VOL 112 in the remote storage device 104 are preferably operated so as to maintain the pair state when the pair state of the S-VOL 111 and the P-VOL 108 in the main storage device 102 is in the duplex state. Because data in the T-VOL 112 is updated synchronously with the update of data in the S-VOL 111 in this case, the S-VOL 111 and T-VOL 112 hold the same data image. In the case where the S-VOL 111 and T-VOL 112 in the remote storage device 104 are controlled so as not to execute synchronous copy in the remote storage device 104, when the request for securing data at the time of the suspend state shown in S208 is received, the synchronization process (including copy from the S-VOL to the T-VOL and the like) of data between the S-VOL 111 and the T-VOL 112 is carried out by the internal copy function.

If the S-VOL 111 and T-VOL 112 are suspended at a timing in which the S-VOL 111 and P-VOL 108 are suspended, the T-VOL 112 can hold at least the same data image as the S-VOL 111 in which data order is maintained. The storage control unit 120 in the remote storage device 104 notifies the storage control unit 120 in the main storage device 102 that the change to the suspend state is completed (S210).

The storage control unit 120 of the main storage device 102 receives a notification about completion of copy from the remote storage device 104 or a notification about completion of suspension of the S-VOL 111 and the T-VOL 112 (S211). Then, write data received from the host system 105 is accumulated in the bit map of the main storage device 102 (S212).

In the description of S204, the case where the microprocessor 119 determines that the quantity of data collected in the side file 116b (utilization of the side file) is larger than the threshold (2) shown in FIG. 4 and smaller than the threshold (1) has been described. However, when the utilization of the side file 116b is higher than the threshold (1), not only the logical volumes holding the log data but also the logical volumes holding the data other than the log data are converted to suspend state.

The procedure for converting from a remote copy state in the side file 116b to the differential data transmission method (method for holding updated data in the bit map) has been described above.

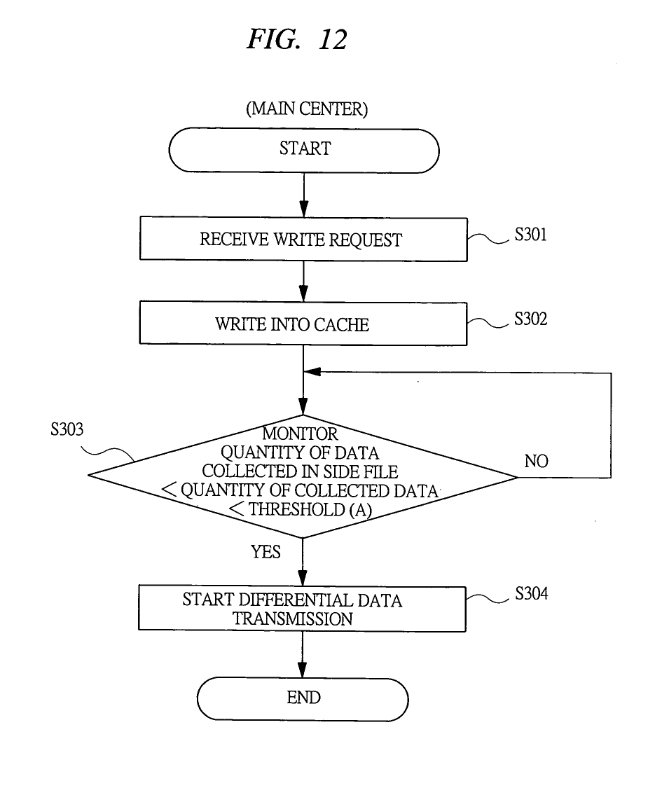

Next, the procedure for transmitting the updated data accumulated in the bit map to the remote storage device 104 will be described with reference to FIG. 12.

When the main storage device 102 receives a write instruction from the host system 105 (S301), the information is accumulated in the cache 116a. At the same time, the location information of the updated data is held in the bit map (S302). The method for using a part of the cache 116a as the bit map is also available.

Next, the microprocessor 119 of the main storage device 102 determines the utilization of the side file 116b (S303). When it is determined that the utilization is lower than the threshold (A) shown in FIG. 4 (YES), transmission of the differential data is started (S304). The pair state of the P-VOL 108 and the S-VOL 111 in this period is changed from the suspend state to rethink state. In this rethink state, the main storage device 102 reads the data corresponding to a data update location recorded in the bit map from the cache 116a and issues the data to the S-VOL 111 of the remote storage device 104 as a write instruction.

Because the update data whose updated part is indicated in the bit map is transmitted in order from the head of addresses during the transmission of this differential data, the S-VOL 111 of the remote center side cannot maintain the update order. However, because the data maintaining the order is accumulated in the T-VOL 112 in S208 to S210 shown in FIG. 11, even if any communication trouble occurs during the transmission of this differential data (S304) or a trouble occurs in the main storage device 102, it is possible to prevent the data in the remote storage device 104 from being lost completely.

The data which the main storage device 102 receives from the host system 105 after the transmission of the differential data is started is accumulated in the side file 116b if the utilization of the side file 116b is lower than a predetermined threshold as described in S202 to S204 of FIG. 11. During the transmission of the differential data, it is always monitored by the storage control unit 120 in the main storage device 102, and if the transmission of the differential data is completed and the utilization of the side file 116b does not exceed a predetermined threshold, the procedure returns to the process for transmitting data of the side file 116b.

Next, the case where the differential data is transmitted in accordance with the differential data transmission method (YES) in S203 of FIG. 11 will be described.

If an area corresponding to the area in which the data is written has been already transmitted to the remote storage device 104 in the remote site, the update data received during the transmission of the differential data is immediately transmitted to the remote site and written therein. In the case where the data has not been transmitted yet, the bit at a location corresponding to an update location in the differential bit map only is turned on. The reason is that the data is transmitted later.

By saving the data up to a location where the update order is ensured in the remote storage device 104 into a different storage region as described above, even if any trouble occurs in the main site of the main storage device 102 during the transmission (recovery copy) of the differential copy data from the main storage device 102 and the recovery copy is interrupted, it is immediately switched to the remote storage device 104 so as to achieve transition of the operation quickly. Further, it is possible to quickly restart the duplication of data by using the data saved in the T-VOL 112.

Consequently, it is possible to automatically perform the control of remote transmission function such as monitoring the quantity of data collected in the side file 116b, controlling the transition to the suspend state depending on the monitoring, and controlling the transition to data duplex state.

### EFFECT OF THE EMBODIMENT

(1) In the case where the quantity of data collected in the side file 116b is monitored and the quantity of the data collected in the side file 116b exceeds a threshold as a result of this monitoring, the data transmission can be automatically interrupted in the order from a small group having a lower utilization in the side file 116b without stopping the data transmission of all the logical volumes in the consistency group. Particularly, the data transmission of the small group of the logical volume of data other than the log data can be interrupted and the data transmission of the small group of the logical volume of the log data can also be interrupted depending on the necessity.

(2) In the case where the quantity of data collected in the side file 116b is monitored and the quantity of the data collected in the side file 116b becomes less than the threshold as a result of this monitoring, the data transmission of the small group whose data transmission is interrupted can be automatically restarted. Particularly, the data transmission of the small group of the logical volume of the data other than the log data can be restarted, and the data transmission of the small group of the logical volume of the log data can be restarted according to need.

(3) Even if a disaster occurs, interruption of the data transmission and automatic restart of the data transmission make it possible to recover the database by using the log data and the data other than the log data in the remote site.

(4) As for the band of the public line 140 for use, since the data transmission can be operated in a band lower than that at a peak time of the data transmission, the public line necessary for the data transmission can be minimized, and thus, the operation cost can be reduced.

In the foregoing, the invention made by the inventor of the present invention has been concretely described based on the embodiments. However, it is needless to say that the present invention is not limited to the foregoing embodiments and various modifications and alterations can be made within the scope of the present invention.

### INDUSTRIAL APPLICABILITY

The remote copy system control technology of the present invention is effective when applied to the establishment of a storage system capable of quickly recovering from a trouble despite its low cost.

What is claimed is:

1. A remote copy system having a first storage device and a second storage device and transmitting data in said first storage device to said second storage device,
wherein each of said first storage device and said second storage device comprises: an interface controller for exchanging data with the outside; a memory for temporarily storing said data; a disk drive for recording said data; a microprocessor for monitoring said data in said memory; a disk controller for controlling write and read of data in said memory to/from said disk drive; and a service processor for setting and controlling the storage devices,
said memory of said first storage device has a side file for storing information for data transmission, and
said service processor of said first storage device has a function to classify a group of logical volumes which ensures the update order of data into a group of the logical volumes for accumulating log data and a group of the logical volumes for data other than the log data, and set the utilization of the side file at which the data transmission is interrupted.

2. The remote copy system according to claim 1,
wherein said microprocessor of said first storage device has a function to monitor the quantity of data collected in said side file and interrupt the data transmission in the order from a group having the lower utilization of the side file set previously in all the logical volumes in said group when the quantity of data collected in said side file exceeds a threshold as a result of the monitoring.

3. The remote copy system according to claim 2,
wherein said microprocessor of said first storage device has a function to restart the data transmission of a group whose data transmission is interrupted when the quantity of data collected in said side file becomes less than a threshold as a result of said monitoring.

4. The remote copy system according to claim 3,
wherein said service processor of said first storage device sets the utilization of the side file for a group of the logical volume of said log data to be high while the utilization of the side file for a group of the logical group of said data other than the log data to be low, and
said microprocessor of said first storage device interrupts the data transmission of a group of the logical volume of said data other than the log data when the quantity of data collected in said side file exceeds a second threshold, and restarts the data transmission of a group of the logical volume of said data other than the log data whose data transmission is interrupted when the quantity of data collected in the side file becomes less than a third threshold lower than said second threshold.

5. The remote copy system according to claim 4,
wherein said microprocessor of said first storage device interrupts the data transmission of the group of the logical volume of said log data when the quantity of data collected in said side file exceeds a first threshold higher than said second threshold, and restarts the data transmission of the group of the logical volume of said log data whose data transmission is interrupted when the quantity of the data collected in the side file becomes less than a fourth threshold lower than said first threshold.

6. The remote copy system according to claim 5,
wherein said disk drive of said first storage device has a first logical volume,
said disk drive of said second storage device has a second logical volume and a third logical volume, and
said microprocessor of each of said first storage device and said second storage device has a function to transmit data from said first logical volume to said second logical volume to make a copy between the storage devices, and make a copy from said second logical volume to said third logical volume within the storage device.

7. The remote copy system according to claim 6,
wherein said microprocessor of each of said first storage device and said second storage device has a function to interrupt a copy from said first logical volume to said second logical volume, make a copy from said second logical volume to said third logical volume within the device, and restore the database by using said log data and said data other than the log data in said third logical volume if a trouble occurs in said first storage device when said log data and said data other than the log data are transmitted from said first logical volume to said second logical volume.

8. The remote copy system according to claim 6,
wherein said microprocessor of each of said first storage device and said second storage device interrupts a copy of the log data from said first logical volume to said second logical volume, copies the log data of said second logical volume to said third logical volume, and restores the database by using the log data and the data other than the log data in said third logical volume if a trouble occurs in said first storage device when said log data is transmitted from said first logical volume to said second logical volume and the transmission of said data other than the log data is interrupted.

9. The remote copy system according to claim 6,
wherein said microprocessor of each of said first storage device and said second storage device interrupts a copy of the log data from said first logical volume to said second logical volume, copies the log data of said second logical volume to said third logical volume, and restores the database by using the log data and the data other than the log data in said third logical volume if a trouble occurs in said first storage device when said log data is transmitted from said first logical volume to said second logical volume, the transmission of the data other than the log data is interrupted and then restarted, and differential data is copied.

10. The remote copy system according to claim 6,
wherein said microprocessor of each of said first storage device and said second storage device restores the database by using the log data and the data other than the log data in said third logical volume if a trouble occurs in said first storage device when the transmission of said log data and said data other than the log data is interrupted or the differential data is copied after said interrupted data transmission is restarted.

11. A control method of a remote copy system,
wherein said remote copy system has a first storage device and a second storage device and transmits data in said first storage device to said second storage device,
each of said first storage device and said second storage device comprises: an interface controller for exchanging data with the outside; a memory for temporarily storing said data; a disk drive for recording said data; a microprocessor for monitoring said data in said memory; a disk controller for controlling write and read of data in said memory to/from said disk drive; and a service processor for setting and controlling the storage devices,
said memory of said first storage device has a side file for storing information for data transmission, and
said service processor of said first storage device classifies a group of logical volumes which ensures the update order of data into a group of the logical volumes for accumulating log data and a group of the logical volumes for data other than the log data, and sets the utilization of the side file at which the data transmission is interrupted.

12. The control method of a remote copy system according to claim 11,
wherein said microprocessor of said first storage device monitors the quantity of data collected in said side file and interrupts the data transmission in the order from a group having the lower utilization of the side file set previously in all the logical volumes in said group when the quantity of data collected in said side file exceeds a threshold as a result of the monitoring.

13. The control method of a remote copy system according to claim 12,
wherein said microprocessor of said first storage device restarts the data transmission of a group whose data transmission is interrupted when the quantity of data collected in said side file becomes less than a threshold as a result of said monitoring.

14. The control method of a remote copy system according to claim 13,
wherein said service processor of said first storage device sets the utilization of the side file for a group of the logical volume of said log data to be high while the utilization of the side file for a group of the logical group of said data other than the log data to be low, and
said microprocessor of said first storage device interrupts the data transmission of a group of the logical volume of said data other than the log data when the quantity of data collected in said side file exceeds a second threshold, and restarts the data transmission of a group of the logical volume of said data other than the log data whose data transmission is interrupted when the quantity of data collected in the side file becomes less than a third threshold lower than said second threshold.

15. The control method of a remote copy system according to claim 14,
wherein said microprocessor of said first storage device interrupts the data transmission of the group of the logical volume of said log data when the quantity of data collected in said side file exceeds a first threshold higher than said second threshold, and restarts the data transmission of the group of the logical volume of said log data whose data transmission is interrupted when the quantity of the data collected in the side file becomes less than a fourth threshold lower than said first threshold.

16. The control method of a remote copy system according to claim 15,
wherein said disk drive of said first storage device has a first logical volume,
said disk drive of said second storage device has a second logical volume and a third logical volume, and
said microprocessor of each of said first storage device and said second storage device transmits data from said first logical volume to said second logical volume to make a copy between the storage devices, and makes a copy from said second logical volume to said third logical volume within the storage device.

17. The control method of a remote copy system according to claim 16,
wherein said microprocessor of each of said first storage device and said second storage device interrupts a copy from said first logical volume to said second logical volume, makes a copy from said second logical volume to said third logical volume within the device, and restores the database by using said log data and said data other than the log data in said third logical volume if a trouble occurs in said first storage device when said log data and said data other than the log data are transmitted from said first logical volume to said second logical volume.

18. The control method of a remote copy system according to claim 16,
wherein said microprocessor of each of said first storage device and said second storage device interrupts a copy of the log data from said first logical volume to said second logical volume, copies the log data of said second logical volume to said third logical volume, and restores the database by using the log data and the data other than the log data in said third logical volume if a trouble occurs in said first storage device when said log data is transmitted from said first logical volume to said second logical volume and the transmission of said data other than the log data is interrupted.

19. The control method of a remote copy system according to claim 16,
wherein said microprocessor of each of said first storage device and said second storage device interrupts a copy of the log data from said first logical volume to said second logical volume, copies the log data of said second logical volume to said third logical volume, and restores the database by using the log data and the data other than the log data in said third logical volume if a trouble occurs in said first storage device when said log data is transmitted from said first logical volume to said second logical volume, the transmission of the data other than the log data is interrupted and then restarted, and differential data is copied.

20. The control method of a remote copy system according to claim 16,
wherein said microprocessor of each of said first storage device and said second storage device restores the database by using the log data and the data other than the log data in said third logical volume if a trouble occurs in said first storage device when the transmission of said log data and said data other than the log data is interrupted or the differential data is copied after said interrupted data transmission is restarted.
